(19) United States
(12) Patent Application Publication
(10) Pub. No.: US 2002/0145507 A1
(43) Pub. Date: Oct. 10, 2002

(54) Integrated biometric security system

(76) Inventor: Ronald R. Foster, Los Gatos, CA (US)

Correspondence Address: Lance A. Termes, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/826,486

(22) Filed: Apr. 4, 2001

(51) Int. Cl. H04Q 1/00; G05B 19/00

(52) U.S. Cl. 340/5.53; 257/423

(57) ABSTRACT

A personal appliance integrated with a biometric security system which includes a CMOS image sensor, a signal processor, and memory, and wherein the biometric security system restricts access to the appliance to authorized individuals, and may be programmed to disable or destroy designated data or other information of a confidential or proprietary nature within the appliance when certain conditions are satisfied.

### TECHNICAL FIELD OF THE INVENTION

The present invention relates generally to biometric devices, and more particularly to a biometric security system integrated with a personal appliance such as a cell phone, pager, personal digital assistant (“PDA”), digital camera, or the like, for preventing unauthorized access to the appliance, or to information or data contained therein.

### BACKGROUND OF THE INVENTION

As the scope and availability of technology expands, the capabilities and functions of a variety of personal appliances continue to proliferate. For example, cell phones and PDAs may now be used to access Internet accounts or web pages to view and/or download personal financial or medical information, electronic or voice mail, and all sorts of related or other information, much of which may be confidential or proprietary in nature. As these functions continue to converge into a single appliance, access to the appliance becomes increasingly valuable, and the need for security of the device is magnified.

One method of securing a device for limited access is through the use of a biometrics recognition application. Biometrics is generally the automatic identification of a person's identity by measurement of a unique physical characteristic by electronic means. Typical biometric systems use digitized images of fingerprints, iris patterns in the eye, hand shape, or hand vein patterns as a basis for identity verification.

Present biometrics applications typically consist of several separate integrated circuits. One of the integrated circuits is dedicated to capturing image data, for example, a charge coupled device (“CCD”) image sensor or a complimentary metal oxide semiconductor (“CMOS”) image sensor. The captured image data is used for comparison with previously captured and distilled image data stored in a separate integrated circuit memory device. The comparison between the captured image and the stored image may be done using a signal processor or microprocessor formed on yet another integrated circuit. In some biometrics systems, the signal processor or microprocessor may be integrated with a memory device, and in others, such as those disclosed in co-pending U.S. patent application Ser. No. 09/546,838 entitled Biometric Device With Integrated CMOS Image Sensor, and incorporated herein by reference, the image capture, signal processing, and memory circuits may all be integrated into a single biometric device formed on an integrated circuit. The availability of a biometric device with an integrated CMOS image sensor, as disclosed in the commonly assigned co-pending application referenced above, contributes to the efficiency of the integration of the biometric device with a relatively compact personal appliance such as a cell phone or PDA.

Typically, after the image data is captured, the image data is processed is such a way as to reduce the amount of data necessary to perform a subsequent pattern matching step. This reduced data set, or “template” may also be stored for later use in the recognition application.

In the case of a security system designed to be used with a personal appliance such as a cell phone or PDA, the biometric recognition application need only address a single or relatively small number of individuals. In these applications, it is important that the biometric device be made as small as possible to maintain the desirable weight and size characteristics of the appliance with which the biometric device is integrated. As such, multiple integrated circuits are undesirable.

### BRIEF DESCRIPTION OF THE VARIOUS VIEWS OF THE DRAWINGS

In the drawings, like reference numerals refer to like parts throughout the various views of the non-limiting and non-exhaustive embodiments of the present invention, and wherein:

FIG. 1 is a schematic diagram of an integrated biometric security system in accordance with the principles of the present invention showing the interrelationship of the component parts in conjunction with an integrated appliance;

FIG. 2 is a pictorial illustration of the image sensor of a biometric security system in accordance with the principles of the present invention showing a standard electro-mechanical switch for actuation of the device;

FIG. 3 is a pictorial illustration, like FIG. 2, of an alternative embodiment of the image sensor of a biometric security system in accordance with the principles of the present invention showing a capacitive switch for actuation of the device; and

FIG. 4 is a flow diagram illustrating the operation of the biometric security system of FIG. 1.

### DETAILED DESCRIPTION OF THE ILLUSTRATED EMBODIMENTS

Biometric systems begin with the measurement of a physiological characteristic. Key to all biometric systems is the underlying assumption that the measured biometric characteristic is both distinctive between individuals and repeatable over time for the same individual. The user's characteristic, such as a fingerprint or iris pattern, must be illuminated with an illumination system and presented to an image sensor. The output of the image sensor is the biometric measure that forms the distinctiveness of the measurement.

In its simplest form, a biometric device acts as an authentication device that compares received data to stored data. In the case of the illustrated embodiments, the biometric device is integrated with an electronic personal appliance and is intended to be employed as a security system for theft deterrence. If the received data matches the stored data, the biometric device will provide a signal to the integrated appliance to “unlock” the device, or to otherwise allow access. If the received data does not match the stored data, then the biometric device will not “unlock” the integrated appliance, and in some cases, may even implement a destruction sequence to destroy some portion of the data stored in the integrated appliance.

The illustrated embodiments disclosed herein provide a biometric security system in the form of a small, low power consuming device which may be integrated with a compact portable, personal electronic appliance such as a cell phone, PDA, or the like, whereby an authorized user may gain access to the appliance via actuation of the security system, and confirmation of the user's identity and access authorization. In a similar manner, the biometric security system may be employed to verify identity and provide access to secure web sites, to make financial transactions, or for other uses where the identity of the individual user must be verified.

Other objects, advantages, and features of the illustrated embodiments will be apparent to the reader from the foregoing and the appended claims, and as the following detailed description and discussion is read in conjunction with the accompanying drawings.

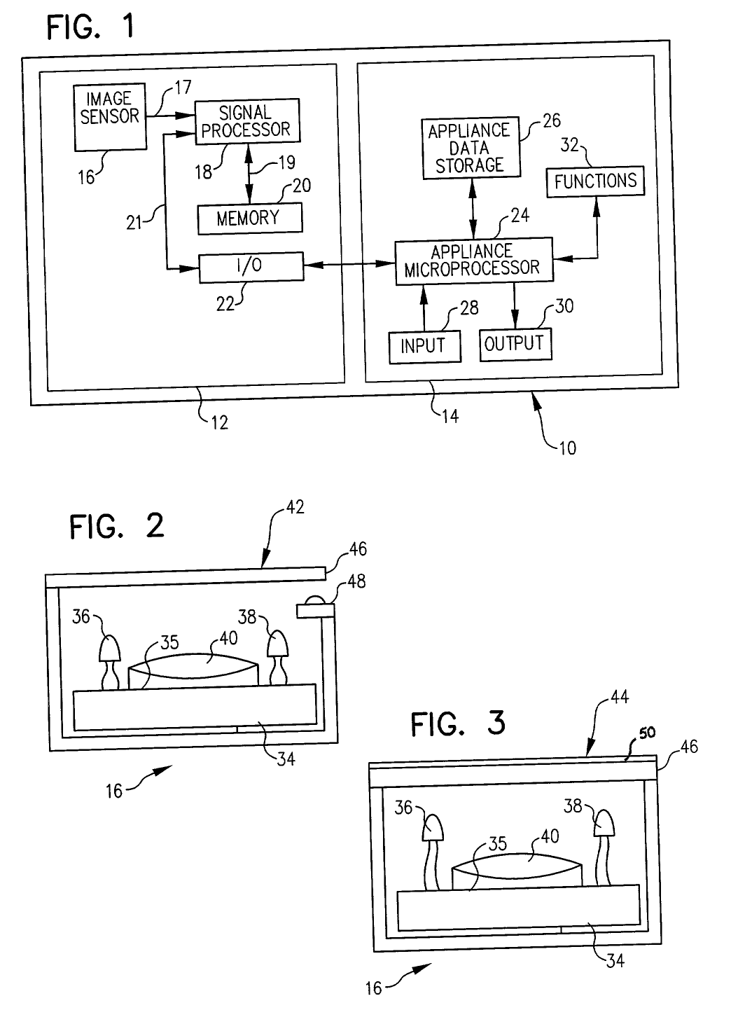

Referring now to the drawings, and in particular to FIG. 1, there is illustrated an appliance generally at 10. The appliance 10 may be a cell phone, a pager, a PDA, a digital camera, a laptop computer, or other portable, personal electronic appliance. The appliance 10 includes a biometric security system 12 integrated with the appliance's standard functional hardware 14. In practice, the biometric security system 12 may replace the conventional send (in the case of a cell phone) or power key (not shown) of the appliance 10.

The biometric security system 12 is preferably formed as a single integrated circuit using standard CMOS processes, and includes a CMOS image sensor 16, a signal processor 18, which may be a microprocessor or a digital signal processor (“DSP”), non-volatile memory 20, and an input/output section 22. When the biometric security system grants access to an authorized user, the standard functional hardware 14 of the appliance becomes accessible. The standard functional hardware may include an appliance microprocessor 24, which may also be substituted for by a DSP, data storage 26, input and output sections 28, 30, and other functions 32 of the appliance which may vary depending on the particular nature of the electronic device. In the case of a cell phone, for example, the other functions may consist of the GSM module and/or other features that carry out the cell phone's communication functions.

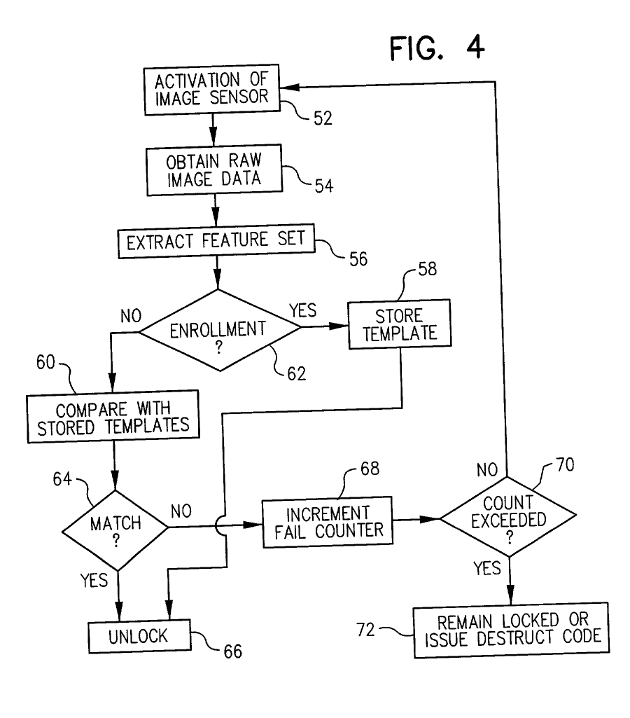

Referring now primarily to FIGS. 2 and 3, the CMOS image sensor 16 (see FIG. 1) is comprised of a CMOS camera chip 34, a pair of light emitting diodes (“LED”) 36, 38, a lens 40, and an external circuit and frame 42 (see FIG. 2), or 44 (see FIG. 3) which controls activation of the image sensor and supports a transparent window 46 which may be comprised of glass or other suitable material. Window 46, in the case of fingerprint imaging, serves to flatten the fingertip as it is pressed against the window, thereby simplifying the design requirements of the optical system. In addition, pressure applied to the window 46 may be used to activate the image sensor and the biometric security system. Although any number of potential embodiments of the external circuit may be used for activation of the image sensor, FIGS. 2 and 3 illustrate a conventional electro-mechanical switching circuit, and a capacitive switching circuit respectively.

With reference primarily to FIG. 2, an electro-mechanical switch 48 is actuated by the downward movement of transparent window 46 when pressure is applied by a user's finger, thereby completing a circuit and powering up the image sensor and biometric security system. Similarly, and with reference to FIG. 3, the image sensor and biometric security system may be activated via a capacitive switch whereby the transparent window 46 is coated with an optically clear, but electrically conductive coating 50 such as indium tin oxide (“ITO”). The change in capacitance caused by a user's finger contacting the conductive surface 50 can be utilized as a switch to activate imaging and processing of the biometric characteristic.

By using an actuateable switch for activation of the image sensor, power need only be supplied to the image sensor when needed for illumination and sensing of a biometric characteristic, thereby conserving the power of the appliance with which the biometric security system is integrated. In the case of an iris scan, a physical on/off switch may be employed in order to conserve power to the image sensor and biometric security system when not in use.

The CMOS camera chip 34 of the image sensor 16 includes a plurality of individual pixels arranged in a two-dimensional array. The CMOS camera chip 34 may be formed in accordance with the designs of the products manufactured by Omnivision Technologies, Inc., the assignee of the present invention. Activation of the image sensor 52 (see FIG. 4) causes light emitting diodes 36, 38 to illuminate the biometric characteristic to be evaluated. The image is focused onto the CMOS camera 34 by a lens 40 positioned between the transparent window 46 and the camera's exposed surface 35 such that the CMOS camera 34 can obtain the raw image data 54 (see FIG. 4) of the biometric characteristic.

The raw image data is then received by the signal processor 18 via a first bus line 17 to begin signal processing. The signal processor 18 (see FIG. 1) is a conventional device capable of executing a set of preprogrammed instructions necessary to carry out the functions of the biometric security system 12. The design of the signal processor 18 may be obtained from any number of companies that provide embedded microprocessor or DSP cores, as applicable. In the context of the presently illustrated embodiments, the signal processor 18 is programmed to obtain raw image data, process the raw image data to extract a feature set, compare the extracted feature set with the template stored in the memory 20, and make a decision based upon the comparison.

The first step performed by the microprocessor 18 in the signal processing sequence is the extraction of a feature set 56 from the raw image data. The feature set extraction process is a form of data compression. The original raw image data typically cannot be reconstructed from the feature set, however, the feature set relates nearly uniquely to a particular individual. A feature set extraction process should deconvolve from the raw image data the true biometric pattern and not the image or sensor characteristics. Second, the feature set should preserve those qualities of the raw image data that are distinctive and repeatable, and discard those qualities that are not distinctive and repeatable.

After extracting the feature set 56 from the raw image data, the signal processor 18 either stores the feature set or “template” 58 in the non-volatile memory 20, or compares the newly extracted feature set or “template” against one or more previously stored templates 60. The signal processor 18 is communicatively connected to the non-volatile memory 20 via a second bus line 19. The non-volatile memory is used to store the template that, when matched to a feature set extracted from the raw image data, will cause the biometric security system 12 to send a control signal through the input/output section 22 via a third bus line 21 to “unlock” the functional hardware 14 of the appliance with which the biometric security system 12 is integrated. Thus, input/output section 22 is used by the biometric security system 12 to communicate with the functional hardware 14 of the integrated appliance.

The decision to store the newly extracted feature set or “template,” or compare the new “template” against existing templates is based on an enrollment condition 62 input by the user via the input/output section 22 of the biometric security system which indicates whether the current image sensing input is a “programming input.” The enrollment process “teaches” the biometric security system who an authorized user is and the physiological characteristics of the particular authorized user. In practice, the system may be designed such that an initialization step permits enrollment of the first template, and thereafter requires identity verification to access the integrated appliance, or to enroll additional templates into the system's memory, which is preferably non-volatile memory. The reader will appreciate that there are various types of memory that may also be used, such as PROM, EPROM, and EEPROM, although anti-fuse technology may be useful where only a one-time programming of the non-volatile memory is required.

In addition, the non-volatile memory 20 may be used to store other types of information not specifically related to the biometric feature. For example, the non-volatile memory 20 may be used to store information relating to the operation of the CMOS image sensor 16 and pixel defect correction data for the CMOS image sensor 16. The non-volatile memory may be programmed using conventional methods via input/output section 22. For example, conventional programming machinery such as a keypad, touchscreen, or the like may be used to apply programming signals to the non-volatile memory 20.

A comparison of the extracted feature set with the existing template(s) stored in the memory 20 of the biometric security system 12 results in a determination as to whether or not a “match” exists. This “match” evaluation is indicted at reference numeral 64 in FIG. 4. The determination of a “match” relies upon the use of statistical metrics. Rarely will the extracted feature set match exactly with the stored template, due to environmental, physiological, and other variables. Therefore, the extracted feature set should be “close enough” to the stored template by a predetermined threshold which may be implemented by an algorithm which may differ with the particular security requirements of each particular application. This control information may be stored in the non-volatile memory 20 as indicated above. In the event of a statistical “match,” the signal processor 18 unlocks 66 the integrated appliance so that the user can access the functional hardware 14 of the device. In the case of enrollment, as discussed above, the comparison process is disregarded and the integrated appliance is unlocked.

In the event that the extracted feature set is not “matched” to a stored template, the signal processor 18 increments a fail counter 68 and determines whether a preprogrammed count maximum has been exceeded 70. If the count maximum has been exceeded, the signal processor 18 maintains the integrated appliance in a locked condition or transmits a signal via input/output section 22 to the appliance microprocessor 24 to destroy data contained in data storage 26. If the count maximum has not been exceeded, the signal processor 18 powers down the biometric security system 12 awaiting a subsequent attempt to access the integrated appliance via activation of the image sensor 52.

While the invention is described and illustrated here in the context of a limited number of embodiments, the invention may be embodied in many forms without departing from the spirit of the essential characteristics of the invention. The illustrated and described embodiments are therefore to be considered in all respects as illustrative and not restrictive. The scope of the invention is indicated by the appended claims rather than by the foregoing description, and all changes which come within the meaning and range of equivalency of the claims are intended to be embraced therein.

What is claimed is:

1. An appliance integrated biometric security system comprising:
an electronic appliance; and
an integrated biometric security system including a CMOS image sensor, a signal processor, and non-volatile memory.

2. An appliance integrated biometric security system as defined in claim 1 wherein the signal processor is selected from the group consisting of: a microprocessor; and a digital signal processor.

3. An appliance integrated biometric security system as defined in claim 1 wherein the non-volatile memory is a programmable read only memory.

4. An appliance integrated biometric security system as defined in claim 1 wherein the electronic appliance is selected from the group consisting of: a cell-phone; a pager; a personal-digital-assistant; a laptop computer; and a digital camera.

5. An appliance integrated biometric security system as defined in claim 1 wherein the non-volatile memory is selected from the group consisting of: electrically erasable programmable read only memory; flash memory; and programmable read only memory.

6. An appliance integrated biometric security system as defined in claim 1 further including an input/output section for programming the non-volatile memory and for communicating with the electronic appliance.

7. An appliance integrated biometric security system as defined in claim 1 wherein the non-volatile memory is used to store a template that identifies an individual authorized to access the electronic appliance.

8. An appliance integrated biometric security system as defined in claim 1 wherein the non-volatile memory is used to store a plurality of templates, each one of the plurality of templates identifying an individual authorized to access the electronic appliance.

9. An appliance integrated biometric security system as defined in claim 8 wherein the non-volatile memory stores a pixel defect map.

10. An appliance integrated biometric security system as defined in claim 1 wherein the CMOS image sensor consists of:
a CMOS camera chip;
a pair of light emitting diodes;
a lens;
a transparent window; and
an actuateable switch for activating the CMOS camera chip and the light emitting diodes.

11. An appliance integrated biometric security system as defined in claim 10 wherein the actuateable switch is an electro-mechanical switch.

12. An appliance integrated biometric security system as defined in claim 10 wherein the actuateable switch is a capacitive switch.

13. An appliance integrated biometric security system comprising:
a portable, personal electronic appliance having functional hardware; and
an integrated biometric security system for authenticating an authorized user of the appliance, including:
a CMOS image sensor for capturing raw image data of a physiological characteristic of a candidate user;
non-volatile memory for storing a template that identifies the authorized user; and
a microprocessor for extracting a feature set from the raw image data, for comparing the feature set to the template and directing the biometric security system to allow access to the functional hardware of the appliance if the feature set is substantially similar to the template.
